(19) United States
(12) Patent Application Publication
(10) Pub. No.: US 2019/0270661 A1
(43) Pub. Date: Sep. 5, 2019

(54) SCALING INHIBITOR AND DISINFECTANT METHOD

(71) Applicants: Marcus G. Theodore, Salt Lake City, UT (US); Terry Gong, Moraga, CA (US)

(72) Inventors: Marcus G. Theodore, Salt Lake City, UT (US); Terry Gong, Moraga, CA (US)

(73) Assignee: Earth Renaissance Technologies, LLC, Salt Lake City, UT (US)

(21) Appl. No.: 16/414,740

(22) Filed: May 16, 2019

Related U.S. Application Data
(63) Continuation-in-part of application No. 16/290,816, filed on Mar. 1, 2019.
(60) Provisional application No. 62/637,530, filed on Mar. 2, 2018.

(51) Int. Cl. C02F 9/00

(52) U.S. Cl. CPC C02F 9/00; C02F 1/74

(57) ABSTRACT

A scaling inhibitor and disinfectant treatment method for waters containing contaminants such as selenium, heavy metals, bicarbonates, and phosphates using sulfurous acid to minimize scaling and prevent biofilms to protect reverse osmosis membranes, brine line conveyance systems, and water processing equipment.

### RELATED APPLICATIONS

The application is a continuation-in-parts patent application of U.S. Ser. No. 16/290,816 filed Mar. 1, 2019 entitled “Treatment Method Reducing Selenium and Heavy Metals in Industrial Wastewaters”, which claims the benefit of US Provisional Patent Application entitled “Treatment Method Reducing Selenium and Heavy Metal in Industrial Wastewaters” filed Mar. 2, 2018, Ser. No. 62/637,530

### BACKGROUND OF THE INVENTION

### Related Applications

The application is a continuation-in-parts patent application of U.S. Ser. No. 16/290,816 filed Mar. 1, 2019 entitled “Treatment Method Reducing Selenium and Heavy Metals in Industrial Wastewaters”, which claims the benefit of US Provisional Patent Application entitled “Treatment Method Reducing Selenium and Heavy Metal in Industrial Wastewaters” filed Mar. 2, 2018, Ser. No. 62/637,530

### Field

This invention pertains to scaling inhibitors and methods to protect water handling equipment and transport systems from scaling, such as cooling towers, reverse osmosis membranes and other wastewater conveyance systems. In particular, it pertains to a lime cation/sulfate alkalinize/sulfurous acid treatment method for all forms of wastewaters to remove bicarbonates, selenium, silica, and heavy metals to levels to minimize scaling. It also disinfects or prevents iron bacteria, manganese bacteria, and other organisms that reduces and/or minimizes the aggregate salt load (TDS) within a system.

As used herein, the term wastewaters are process waters, agricultural, petrochemical, industrial manufacturing, boiler blowdown, electric power production, and mining waters containing heavy metals, silica, perchlorates, selenium, and bicarbonates. Heavy metals are defined as aluminum, barium, bismuth, cadmium, chromium, cobalt, copper, iron, lead, lithium, magnesium, mercury, nickel, scandium, silver, strontium, thallium, tin, and zinc.

### STATE OF THE ART

A wide variety of water treatment chemicals are employed for various applications according to Lenntech; see lenntech.com/products/chemicals/water-treatment-chemicals.htm#ixzz5kEfd8kFg, such as:

Oxygen scavenging

Scale inhibition

Corrosion inhibition

Antifoaming

Alkalinity control.

Coagulants.

Oxygen scavenging prevents oxygen from introducing oxidation reactions particularly with organics, which have a slightly negative charge that can absorb oxygen molecules. To prevent oxidation reactions from taking place in water. Examples of oxygen scavengers include volatile products, such as hydrazine (N₂H₄), carbohydrazine, hydroquinone, diethylhydroxyethanol, methylethylketoxime, and non-volatile salts, such as sodium sulphite (Na₂SO₃) and other salts such as cobalt chloride catalyzing compounds to increase the rate of reaction with dissolved oxygen, for instance cobalt chloride.

Scale inhibition are surface-active negatively charged polymers, which prevent scale precipitate that forms on surfaces in contact with water as a result of the precipitation of normally soluble solids that become insoluble as temperature increases such as calcium carbonate, calcium sulfate, and calcium silicate. The polymers attach in the scale structure disrupting crystallization. The particles of scale combined with the inhibitor are then dispersed, remaining in suspension. Examples of scale inhibitors are phosphate esters, phosphoric acid and solutions of low molecular weight polyacrylic acid.

Antiscalents are particularly used for cooling water systems are subject to a variety of contaminants that can interfere with heat transfer, increase corrosion rates, restrict water flow, and cause process efficiency and production loss. Customized scale inhibitor programs are necessary for mineral scale and sludge prevention such as calcium carbonate, calcium sulfate, calcium phosphate, magnesium silicate, silica compounds, and mixtures of these.

Antiscalents are also used to minimize sludge and organics, such as biological deposits, metallic oxides, corrosion products, oil, organics, and process contaminants.

The use of high performance RO membrane scale inhibitors is an essential component to any good reverse osmosis plant management program. Reverse osmosis plant recovery rates vary from as low as 10% in the case of sea water to 90% with some low salinity brackish waters. As the water passes along the membrane surface, the salt concentration increases and some sparingly soluble salts exceed their solubility products. These salts can precipitate on the membrane surface causing fouling which may reduce output and increase the product water conductivity. The two most troublesome salts are calcium carbonate and calcium sulfate. Their prevention is essential if the membrane is to work efficiently. Sulfuric acid has traditionally been used to ‘de-alkalize’ the feed water for preventing calcium carbonate scaling. However, sulfuric acid is hazardous to handle, increases the sulfate content of the water and can add to the general corrosiveness of the water on both sides of the membrane.

Calcium sulfate scale can be eliminated by lowering the recovery rate, which reduces the calcium and sulfate ion concentration in the water. Reducing the recovery rate is not always the best option as it means running the plant at lower efficiency. The best way to maintain cost effective production is to operate with recovery rates as high as possible whilst at the same time preventing membrane scaling.

ROCscale products are used as membrane scale inhibitors or antiscalants can be dosed either before or after the system cartridge filters in a typical reverse osmosis system. If iron is present in the feed water, the antiscalant can be dosed post to prevent “pick-up” of iron, or in the case of polymer antiscalants de-activation by iron. Under these circumstances a phosphonate based product with good iron sequestering properties may be employed. The dose point for the selected antiscalant should be after the sodium sulfite/bi-sulfite (SBS) injection to ensure chlorine is removed (especially with high levels of free chlorine). The dose point should be sufficiently down-stream of the SBS injection point to avoid “neat” product mixing where water is mixed with the antiscalent.

The function of a dispersant or antifoulant is to prevent the agglomeration of solids and their accumulation on critical surfaces. Materials that handle these potential deposits have been referred to in the industry as dispersants, polymers, penetrating agents, deposit control materials, polyelectrolytes, crystal modifiers, antifoulants, sequestrants, mineral stabilizers, antiscalants, surfactants, threshold treatments, mud removers, and emulsifiers.

Corrosion inhibition prevents the conversion of a metal into a soluble compound. Corrosion inhibitors are applied to prevent corrosion can lead to failure of critical parts of various systems, deposition of corrosion products in heat exchange areas, and overall efficiency loss. Corrosion inhibitors are chemicals that react with a metallic surface, usually adsorbing themselves into a film to protecting the metallic surface.

There are five different kinds of corrosion inhibitors:

Passivity inhibitors (passivators). These cause a shift of the corrosion potential, forcing the metallic surface into the passive range. Examples of passivity inhibitors are oxidizing anions, such as chromate, nitrite and nitrate and non-oxidizing ions such as phosphate and molybdate. These inhibitors are the most effective and consequently the most widely used.

Cathodic inhibitors. Some cathodic inhibitors, such as compounds of arsenic and antimony, work by making the recombination and discharge of hydrogen more difficult. Other cathodic inhibitors, ions such as calcium, zinc or magnesium, may be precipitated as oxides to form a protective layer on the metal.

Organic inhibitors. These affect the entire surface of a corroding metal when present in certain concentration. Organic inhibitors protect the metal by forming a hydrophobic film on the metal surface. Organic inhibitors will be adsorbed according to the ionic charge of the inhibitor and the charge on the surface.

Precipitation inducing inhibitors. These are compounds that cause the formation of precipitates on the surface of metal; thereby providing a protective film. The most common inhibitors of this category are silicates and phosphates.

Volatile Corrosion Inhibitors (VCI). These are compounds transported in a closed environment to the site of corrosion by volatilization from a source. Examples are morpholine and hydrazine and volatile solids such as salts of dicyclohexylamine, cyclohexylamine and hexamethylene-amine. On contact with the metal surface, the vapor of these salts condenses and is hydrolyzed by moist, to liberate protective ions.

Anti-foaming is a chemical additive that reduces and hinders the formation of foam in industrial process liquids. Common de-foaming agents are insoluble oils, polydimethylsiloxanes and other silicones, certain alcohols, stearates and glycols. The additive is used to prevent formation of foam or is added to break a foam already formed that cause defects on surface coatings and prevent the efficient filling of containers.

Generally a defoamer is insoluble in the foaming medium and has surface active properties. An essential feature of a defoamer product is a low viscosity and a facility to spread rapidly on foamy surfaces. It has affinity to the air-liquid surface where it destabilizes the foam lamellas. This causes rupture of the air bubbles and breakdown of surface foam. Entrained air bubbles are agglomerated, and the larger bubbles rise to the surface of the bulk liquid more quickly

Alkalinity Control chemicals neutralize acids and basics. Usually either sodium hydroxide solution (NaOH), calcium carbonate, or lime suspension (Ca(OH)₂) are used to increase pH levels. Diluted sulfuric acid (H₂SO₄) or diluted hydrochloric acid (HCl) is used to reduce pH levels. The dose of neutralizing agents depends upon the pH of the water in a reaction basin. Neutralization reactions cause a rise in temperature.

Coagulation flocculation involves the addition of polymers that clump the small, destabilized particles together into larger aggregates so that they can be more easily separated from the water. Coagulation is a chemical process that involves neutralization of charge whereas flocculation is a physical process and does not involve neutralization of charge. The coagulation-flocculation process can be used as a preliminary or intermediary step between other water or wastewater treatment processes like filtration and sedimentation. Iron and aluminum salts are the most widely used coagulants but salts of other metals such as titanium and zirconium have been found to be highly effective as well. Preferred coagulants are positive ions with high valence, such as aluminum and iron applied as Al₂(SO₄)³⁻ (alum) and iron as either FeCl₃ or Fe₂(SO₄)³⁻. One can also apply the relatively cheap form FeSO⁴, on condition that it will be oxidized to Fe³⁺ during aeration. Coagulation is very dependent on the doses of coagulants, the pH and colloid concentrations. To adjust pH levels Ca(OH)₂ is applied as co-flocculent. Doses usually vary between 10 and 90 mg Fe³⁺/L, but when salts are present a higher dose needs to be applied.

Polymer flocculants (polyelectrolytes) may also be used to promote bond formation between polymers

Disinfection may also be required to kill unwanted microorganisms present in water, such as chlorine, chlorine dioxide, hypochlorite, and ozone. UV has the added advantage of leaving few chemical by-products. These polymers have a very specific effect, dependent upon their charges, their molar weight and their molecular degree of ramification. The polymers are water-soluble and their molar weight varies between 10 and 10⁶ g/mol. There can be several charges on one flocculent. There are cationic polymers, based on nitrogen, anionic polymers, based on carboxylate ions and polyampholytes, which carry both positive and negative charges.

Often oxidants may be added, such as ozone, peroxide, and oxygen to reduce COD/BOD levels and remove organic and oxidizable inorganic components. The processes can completely oxidize organic materials to carbon dioxide and water, although it is often not necessary to operate the processes to this level of treatment.

pH conditioners may be added to prevent corrosion from pipes and to prevent dissolution of lead into water supplies. During water treatment pH adjustments may also be required. The pH is brought up or down through addition of basics or acids.

Resin cleaners are required to regenerate ion exchange resins for reuse. These may cause serious fouling with contaminants that enter the resins needing cleaning with certain chemicals, such as sodium chloride, potassium chloride, citric acid and chlorine dioxide. Chlorine dioxide cleansing serves the removal of organic contaminants on ion exchange resins. Prior to every cleaning treatment resins should be regenerated. After that, in case chlorine dioxide is used, 500 ppm of chlorine dioxide in solution is passed through the resin bed and oxidizes the contaminants.

Heavy metals and selenium removal are also required before open stream discharge, usually via chemical co-precipitation of metal hydroxides or membrane filtration. Because selenium and heavy metals in high concentrations are hazardous to public health, the Environmental Protection Agency Secondary Drinking Water Standards has set water primary and secondary standards for selenium and heavy metal concentrations in drinking water and in waters before discharge into open streams or land application:

| | | |
|---|---|---|
| Aluminum | 0.05 to 0.2 mg/L | (50 to 200 μ/L) |
| Arsenic | 0.010 mg/L | (10 μ/L) |
| Antimony | 0.006 | (6 μ/L) |
| Barium | 2 mg/L | (2000 μ/L) |
| Beryllium | 0.004 mg/L | (4 μ/L) |
| Cadmium | 0.005 mg/L | (5 μ/L) |
| Chromium | 0.1 mg/L | (100 μ/L) |
| Copper | 1.3 mg/L | (130 μ/L) |
| Iron | .3 mg/L | (300 μ/L) |
| Lead | 0.015 mg/L | (15 μ/L) |
| Manganese | 0.05 mg/L | (50 μ/L) |
| Mercury | 0.002 mg/L | (2 μ/L) |
| Nickel | 0.1 mg/L | (100 μ/L) |
| Selenium | 0.05 mg/L | (50 μ/L) |
| Silver | 0.1 mg/L | (100 μ/L) |
| Thallium | 0.002 mg/L | (2 μ/L) |
| Zinc | 5 mg/L | (5000 μ/L) |

Lead and copper are regulated by a treatment technique that requires systems to control the corrosiveness of their water. If more than 10% of tap water samples exceed the action level, water systems must take additional steps. For copper, the action level is 1.3 mg/L, and for lead is 0.015 mg/L.

EPA Secondary Drinking Water Standards: Guidance for Nuisance Chemicals; for iron is not hazardous to health, but is considered a secondary contaminant with 1.3 mg/L leaving reddish brown stains on fixtures.

Zinc is also a secondary standard where 5 mg/L leaves a metallic taste.

The pre-treatment method described below provides an inexpensive chemical treatment method first adding lime coagulants forming salt and carbonate precipitates above pH 8.5 for filtration removal before adding sulfurous acid as an antiscalent reducing agent to the filtrate to reduce the pH of the filtrate around 6.5 to produce a bisulfite enriched disinfectant treated water eliminating bicarbonate and biofilm buildup in equipment, particularly for more efficient reverse osmosis membrane operations, and cooling tower operations to control the Langelier Saturation Index so that the feed-water flowing into or the brine flowing out of them doesn‘t’ result in scale formation or is corrosive to the system's infrastructure.

According to Wikepedia, the Langelier saturation index is a calculated number used to predict the calcium carbonate stability of water. It indicates whether the water will precipitate, dissolve, or be in equilibrium with calcium carbonate. The LSI is expressed as the difference between the actual system pH and the saturation pHs:

LSI=pH(measured)−pHs

For LSI>0, water is super saturated and tends to precipitate a scale layer of CaCO₃.

For LSI=0, water is saturated (in equilibrium) with CaCO₃. A scale layer of CaCO₃ is neither precipitated nor dissolved.

For LSI<0, water is under saturated and tends to dissolve solid CaCO₃.

If the actual pH of the water is below the calculated saturation pH, the LSI is negative and the water has a very limited scaling potential. If the actual pH exceeds pHs, the LSI is positive, and being supersaturated with CaCO₃, the water has a tendency to form scale. At increasing positive index values, the scaling potential increases.

In practice, water with an LSI between −0.5 and +0.5 will not display enhanced mineral dissolving or scale forming properties. Water with an LSI below −0.5 tends to exhibit noticeably increased dissolving abilities while water with an LSI above +0.5 tends to exhibit noticeably increased scale forming properties.

The LSI is temperature sensitive. The LSI becomes more positive as the water temperature increases. This has particular implications in situations where well water is used. The temperature of the water when it first exits the well is often significantly lower than the temperature inside the building served by the well or at the laboratory where the LSI measurement is made. This increase in temperature can cause scaling, especially in cases such as hot water heaters. Conversely, systems that reduce water temperature will have less scaling.

LSI example for a Water Analysis:

pH=7.5

TDS=320 mg/L

Calcium=150 mg/L (or ppm) as CaCO₃

Alkalinity=34 mg/L (or ppm) as CaCO₃

LSI is calculated using the LSI Formula:

LSI=pH−pHs

pHs=(9.3+A+B)−(C+D) where:

A=(Log₁₀[TDS]−1)/10=0.15

B=−13.12×Log₁₀(C+273)+34.55=2.09 at 25° C. and 1.09 at 82° C.

C=Log₁₀[Ca²⁺as CaCO₃]−0.4=1.78

(Ca²⁺ as CaCO₃ is also called Calcium Hardness and is calculated as=2.5(Ca²⁺))

D=Log₁₀[alkalinity as CaCO₃]=1.53

LSI=7.5−(9.3+0.15+2.09)+(1.78+1.53)=−0.73 predicting that the water is under saturated and tends to dissolve solid CaCO₃,but is corrosive.

Although the bicarbonates are the main cause of scaling or fouling, other silicates and organics also must be considered. Silica and many organics precipitate in acidic solutions where inorganic salts are present or added to form silica and organic flocs removed by precipitation. Different pH levels are used depending upon the salts employed. Generally, lime and soda ash are employed for precipitation, but ferric and aluminum and magnesium salts may also be used. The method described below provides a method for reducing scaling of a variety of these water contaminants, while preventing biofilm buildup.

### SUMMARY OF THE INVENTION

The method is a scaling inhibitor and disinfectant method comprising injecting sulfur dioxide into water containing bicarbonates to adjust its pH to approximately 6.5 for bicarbonate reduction, and precipitate silicates for removal to reduce equipment and conveyance scaling. The sulfur dioxide may be produced by an on-site sulfurous acid generator burning raw sulfur for injection into the wastewaters and brine lines.

For reverse osmosis treatment, the scaling inhibitor and disinfectant treatment method for reverse osmosis membranes comprises first raising the pH of waters entering reverse osmosis membranes above pH 8.5 with lime to form metal hydroxide precipitates, calcium precipitates, and metal sulfate precipitates. The precipitates are then removed forming a salt reduced filtrate. Sulfurous acid is then added to the salt reduced filtrate to adjust the pH of the filtrate around 6.5 to reduce bicarbonates, precipitate silicates for removal, and add bisulfites/sulfites for biofilm reduction and reduced loading on the reverse osmosis membranes.

The filtrate may be further exposed to ultra violet light to kill microorganisms. As industrial wastewaters from cooling towers may be infected with pathogens and viruses, the ultraviolet light exposure time of the method is selected to be sufficient to destroy any pathogens and viruses-usually 2 hour or less.

This water treatment method employs a number of chemical reductants reducing oxygen levels and may require oxidation via aeration or ozonation of the treated water to provide dissolved oxygen for open stream discharge.

The water treatment method thus provides an economical, fast chemical coagulation removal method and antiscalent to meet different effluent discharge requirements.

### DESCRIPTION OF THE DRAWINGS

FIG. 1 is a sulfurous acid specie concentration curve for various pH levels.

FIG. 2 is a Langelier Saturation Index chart.

FIG. 3 is a Langelier Saturation Index (SI) Table.

FIG. 4 is a water scale formation chart showing pH dependency.

The patent or application file contains at least one drawing executed in color. Copies of this patent or patent application publication with color drawing(s) will be provided by the Office upon request and payment of the necessary fee.

### DESCRIPTION OF THE ILLUSTRATED EMBODIMENTS

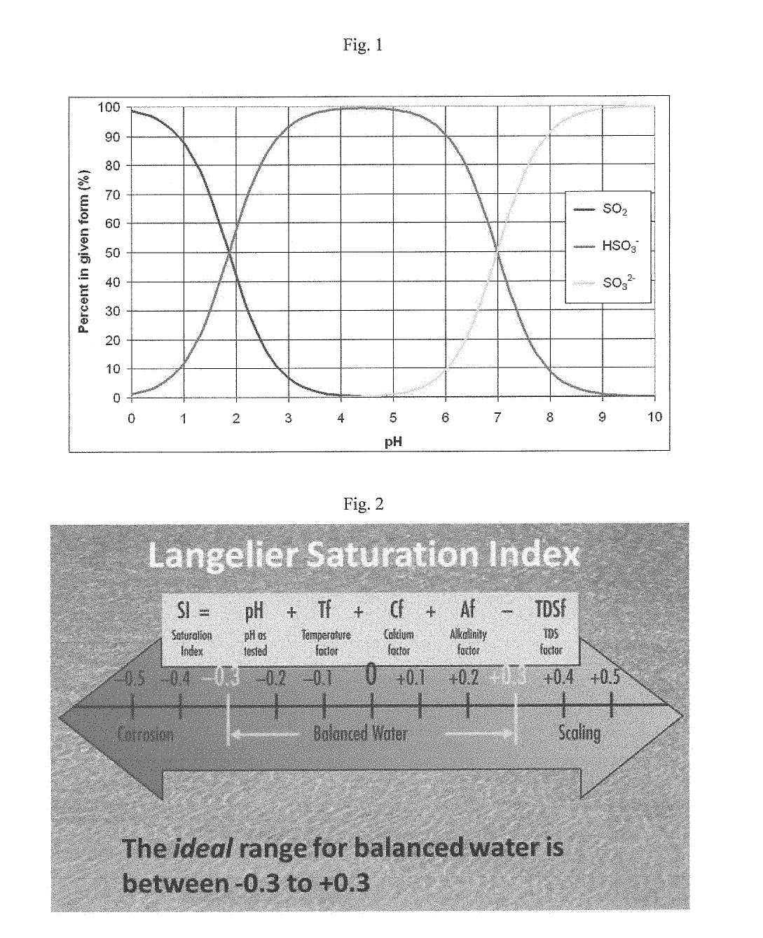

FIG. 1 is a sulfurous acid specie concentration curve for various pH levels.

FIG. 2 is a Langelier Saturation Index chart.

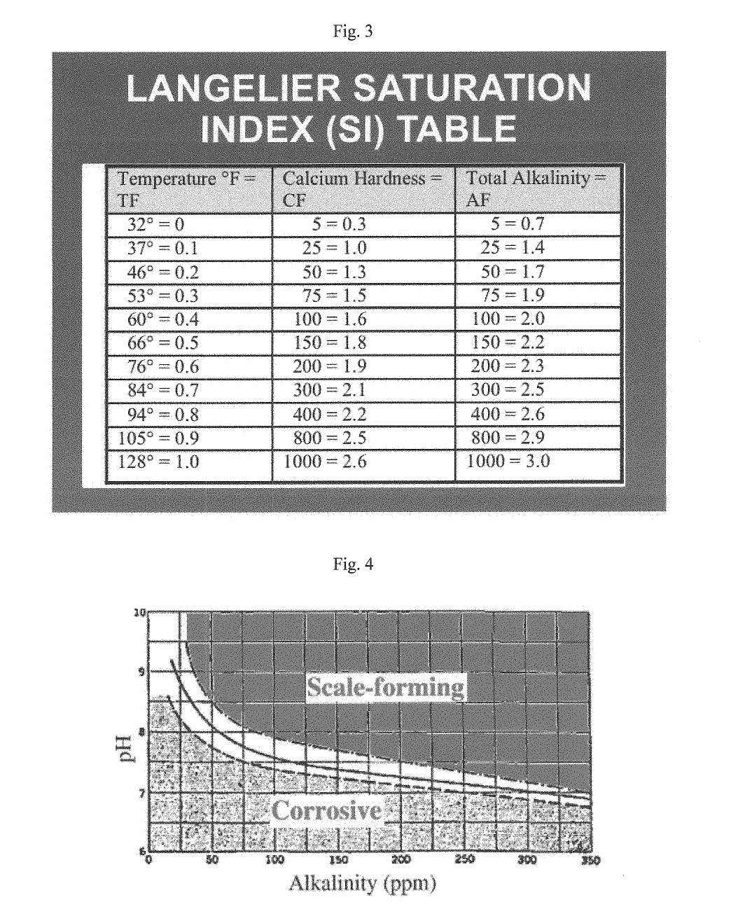

FIG. 3 is a Langelier Saturation Index (SI) Table.

FIG. 4 is a water scale formation chart showing pH dependency.

To evaluate this antiscaling chemical reduction/precipitation and removal method, WesTech Engineering, Inc. of Salt Lake City, Utah provided certain selenium contaminated waters high in heavy metals in feed waters having 0.0976 mg/L selenium from a power plant's flue gas desulfurization (FGD) once-through cleaning stream, which was 48 times the reporting limit of 0.002 mg/l during its passage through the system as well as lab equipment and testing personnel assistance.

500 ml of the raw composite second sample was then drawn and 10 ml ferric sulfate (67 gr/L or 0.1678 m/L) was added to the sample forming a slightly orange solution with a pH of 2.65.

Approximately 200 ml of lime water (1.5 gr/L at 25 degrees C.) was then added to raise the pH to 10.01 and stirred for 16 minutes until a ferric/metal hydroxide and metal/calcium sulfate precipitate layer was formed.

The ferric/metal hydroxide and calcium/metal sulfate precipitate bed layer was approximately 1/7^{th} (100 ml thick) and had a pH 9.62 of the 700 ml solution

Sulfurous acid (H₂O+SO₂═H₂SO₃=H⁺+HSO3⁻) also releases SO₂ out of solution at low pH shifts. The amount of sulfurous acid free SO₂, sulfite, and bisulfite in aqueous solutions vary based on acid pH concentration as illustrated in FIG. 1 showing the distribution of the different species at various pH values.

At the low pH 2.5 conditions, sulfurous acid releases significant free SO₂.

On Nov. 27, 2017, a composite raw selenium sample was prepared having a pH of 7.87 with a yellow tinge, and sent to American West Analytics Laboratories in Salt Lake City, Utah to test for total selenium, and heavy metals As, Hg, Pb, Fe, Zn, Cu, and Cr. The American West Analytics Laboratories independent lab test results showed:

| | | |
|---|---|---|
| Arsenic | <.00200 | mg/L |
| Chromium | <.00200 | mg/L |
| Copper | 0.00512 | mg/L |
| Iron | 0.18800 | mg/L |
| Lead | <00200 | mg/L |
| Mercury | 0.00218 | mg/L |
| Selenium | 0.0563 | mg/L |
| Zinc | 0.0926 | mg/L |

Testing of the second raw sample with ferric sulfate addition to add additional iron and sulfates coupled with lime addition was then performed as outline below. Sulfurous acid ultra violet light treatment of the filtrate was also performed to alter the selenium species composition.

500 ml of the raw composite second sample was drawn and 10 ml ferric sulfate reducing agent (67 gr/L or 0.1678 m/L) was added to the sample forming a slightly orange solution with a pH of 2.65.

Approximately 200 ml of lime water (1.5 gr/L at 25 degrees C.) was then added to raise the pH to 10.01 and stirred for 16 minutes until a ferric/metal hydroxide and metal/calcium sulfate precipitate layer was formed.

The ferric/metal hydroxide and calcium/metal sulfate precipitate bed layer was approximately 1/7^{th} (100 ml thick) and had a pH 9.62 of the 700 ml solution. To determine if the ferric sulfate/lime co-precipitate floc reduced the total selenium and any selenate/selenite to base elementary selenium to co-precipitate with the ferric hydroxide floc, the co-precipitates were decanted and removed by 0.45 μm filtration forming a clear slightly yellow tinged filtrate.

Approximately half of the filtrate (250 ml) was then sent to the TestAmerica Lab for selenium speciation testing to determine if ferric sulfate addition alone is sufficient to reduce the individual selenite/selenate levels below 1 μg/L. The TestAmerica Lab results showed a selenate concentration of 24 μ/L and a selenite concentration of 1.8 μ/L, which did not meet the threshold levels required for 25 MW power plant discharge or clean water compliance.

The TestAmerica Lab UV sample results showed total selenium was 48 μ/L, again well above the power plant discharge level of 5 μ/L, but within clean water compliance.

The other approximately half of the filtrate (300 ml) was further reduced with the addition of 10 ml pH 1.1 sulfurous acid addition, which lowered the filtrate to pH 2.49 forming a clear filtrate solution.

This clear filtrate solution was then irradiated with UV-L light (λ 253.7 nm) light for ½ hour. The acidified UV sample was then sent to the Denver TestAmerica Lab for comparison selenium speciation testing and total selenium and heavy metals testing. This last sample met all the clean water guidelines with the exception of mercury and reflected a reduction of any the selenite/selenate species remaining.

| Results | | | EPA Standard | |
|---|---|---|---|---|
| Arsenic | ND | | 0.010 mg/L | (10 μg/L) |
| Chromium | 3.8 | μg/L | 0.1 mg/L | (100 μg/L) |
| Copper | 7.3 | μg/L | 1.3 mg/L | (130 μg/L) |
| Iron | 210 | μ/L | .3 mg/L | (300 μg/L) |
| Lead | ND | | 0.015 mg/L | (15 μg/L) |
| Mercury | 0.6 | μg/L | 0.002 mg/L | (2 μg/L) |
| Selenium | 18 | μg/L | 0.05 mg/L | (50 μg/L) |
| Zinc | 15 | μg/L | 5 mg/L | (5000 μg/L) |

The exact pH for metal hydroxide removal was selected upon presence of the metal species to be removed. For example, pH 9 is selected for copper precipitation. pH 10 is used for lead removal, and pH 9.5 for zinc removal. Mercury can be co-precipitated with ferric sulfate by elevating the pH to 8; see “Co-precipitation of Mercury (II) with Iron (III) Hydroxide”, Yoshikazu Inoue et al, Environmental Science and Technology, 1979, 13(4), pp 443-445.

The selenium species are important as each poses a different hazard to humans. Toxic levels of selenium in the form of SeCN— (selenocyanate) being the most hazardous as opposed to selenite and selenate; see “The acute bacterial toxicity of selenocyanate anion and the bioprocessing of selenium by bacterial cells”, Environmental Biotechnology 8(1) 2012, pp. 32-38. Based on the ferrous/ferric treatment test results followed by UV energized bisulfite/sulfite treatment of the filtrates, selenite was reduced to the lowest levels, leaving only selenate in solution.

On Feb. 7, 2018 confirmation tests were conducted using powdered ferrous sulfate and lime to avoid any dilution effects from previously using limewater pH adjustment. A clear composite raw selenium sample was prepared having a pH of 7.97, and sent to American West Analytics Laboratories to test for total selenium, and heavy metals As, Hg, Pb, Fe, Zn, Cu, and Cr.

The American West Analytics Laboratories independent lab test results showed:

Nov. 27, 2017 Raw Sample 2

| | | |
|---|---|---|
| Arsenic | <.00200 | mg/L |
| Chromium | <.00200 | mg/L |
| Copper | 0.00624 | mg/L |
| Iron | <0.100 | mg/L |
| Lead | <00200 | mg/L |
| Mercury | 0.000860 | mg/L |
| Selenium | 0.0529 | mg/L |
| Zinc | 0.0668 | mg/L |

This raw sample almost met the clean water total selenium 0.05 mg/L threshold.

Powdered ferrous sulfate was added to the second raw sample to add additional iron and sulfates followed by powdered lime addition to avoid dilution effects. Sulfurous acid UV treatment of the filtrates was then performed to alter the selenium species composition.

Specifically, 600 ml of the raw composite second sample was drawn and approximately 1 gram of Calcium Hydroxide to adjust the pH to 9.03 resulting in a slight white flock.

Approximately 1 gram of ferrous sulfate reducing agent [sat-30.4 gr/L Heptahydrate (FeSO₄.7H₂O-278.02 g/m) or 0.11 m/L (light green at 20.2° C., pH 3.53)] was added to the elevated pH third sample forming a cloudy iron colored solution with a pH of 7.86. Additional calcium hydroxide was added to raise the pH to 9.21 and stirred for 10 minutes until a ferric/metal hydroxide and metal/calcium sulfate precipitate and maghemite 50 ml layer was formed.

The suspended solids were decanted and filtered producing a clear pH 9.18 filtrate.

250 ml filtrate was sent to American West Analytical for total selenium and metals testing to determine the effects ferrous sulfate/lime addition alone on total selenium and heavy metals reduction. [0.45 μm filter paper was used separating a much darker iron colored black precipitate]. The American West Analytical tests showed the following:

| Results | | | EPA Clean Water Standard | |
|---|---|---|---|---|
| Arsenic | <0.002 | mg/L | 0.010 mg/L | (10 μ/L) |
| Chromium | <0.00200 | mg/L | 0.1 mg/L | (100 μ/L) |
| Copper | 0.00615 | mg/L | 1.3 mg/L | (130 μ/L) |
| Iron | <0.100 | mg/L | .3 mg/L | (300 μ/L) |
| Lead | <0.002 | mg/L | 0.015 mg/L | (15 μ/L) |
| Mercury | 0.000430 | mg/L | 0.002 mg/L | (2 μ/L) |
| Selenium | 0.0475 | mg/L | 0.05 mg/L | (50 μ/L) |
| Zinc | <0.00500 | mg/L | 5 mg/L | (5000 μ/L) |

Next, ˜10 ml pH 1.1 sulfurous acid was added to 250 ml of the clear filtrate to lower the pH to 5.79 forming a clear filtrate solution and irradiated the with UV-L light (253.7 nm) light for ½ hour. The EPA National Primary Drinking Water Regulations, 40 CFR 141, https://www.epa.gov/ground-water- and drinking-water/national-prima . . . Jan. 2, 2018 is shown in the right column below:

| Results | | | EPA Standard | |
|---|---|---|---|---|
| Arsenic | 0.002 | mg/L | 0.010 mg/L | (10 μ/L) |
| Chromium | <0.00200 | mg/L | 0.1 mg/L | (100 μ/L) |
| Copper | 0.00401 | mg/L | 1.3 mg/L | (130 μ/L) |
| Iron | <0.182 | mg/L | .3 mg/L | (300 μ/L) |
| Lead | <0.002 | mg/L | 0.015 mg/L | (15 μ/L) |
| Mercury | 0.000357 | mg/L | 0.002 mg/L | (2 μ/L) |
| Selenium | 0.0440 | mg/L | 0.05 mg/L | (50 μ/L) |
| Zinc | 0.018 | mg/L | 5 mg/L | (5000 μ/L) |

The irradiated filtrate was again filtered and sent to the TestAmerica Lab for selenium speciation testing. The filter showed a minimal light grey precipitate.

The TestAmerica Lab UV sample results showed a total selenium level of 48 μ/L, a selenate concentration of 32 μ/L and a selenite concentration of 1.8 μ/L, which met the clean water standards, but did not meet the 1 μ/L threshold levels for selenite and selenate, and total selenium of 5 u/L required for power plant discharge under 40 CFR 423.

To test the effects of an additional reducing agent, the first three steps were repeated first adjusting the pH to 9.07 with approximately 1 gram of Calcium Hydroxide, and adding approximately 1 gram of ferrous sulfate producing a cloudy iron colored solution with a pH of 7.4. Additional calcium hydroxide was added to raise the pH to 9.04 and stirred for 10 minutes until the ferric/metal hydroxide and metal/calcium sulfate precipitate and maghemite layer was formed and removed via filtration.

The filtrate was reduced to pH 6.02 with ˜2 ml sulfurous acid (0.1M).

6.5 ml sodium sulfide solution (0.1M) was then added to the filtrate to precipitate metal sulfides and selenium (II) sulfide, selenium (IV) sulfide precipitates. The sodium sulfide treatment formed a light grey film on the filter paper vs the orange-brown ferrous sulfate precipitates.

250 ml of the second filtrate was sent to the American West Analytical lab for total selenium and heavy metals analysis. The American West Analytical showed the following results:

| Results | | | EPA Drinking Water Standard | |
|---|---|---|---|---|
| Arsenic | 0.00213 | mg/L | 0.010 mg/L | (10 μ/L) |
| Chromium | <0.00200 | mg/L | 0.1 mg/L | (100 μ/L) |
| Copper | 0.00401 | mg/L | 1.3 mg/L | (130 μ/L) |
| Iron | 0.182 | mg/L | .3 mg/L | (300 μ/L) |
| Lead | <0.002 | mg/L | 0.015 mg/L | (15 μ/L) |
| Mercury | 0.000357 | mg/L | 0.002 mg/L | (2 μ/L) |
| Selenium | 0.0440 | mg/L | 0.05 mg/L | (50 μ/L) |
| Zinc | 0.0108 | mg/L | 5 mg/L | (5000 μ/L) |

The results were again within the clean water discharge standards, but not within the power plant discharge standards.

Lastly, ˜2 ml pH 1.1 sulfurous acid was added to 250 ml of the second filtrate to lower the pH to 6.48 forming a fairly clear filtrate solution, which was irradiated with UV-L light (λ 253.7 nm) light for ½ hour. After filtering, a much darker precipitate was left on the filter compared to the lighter grey film on the previous filter. This would appear to be metal sulfides, as selenium sulfides are orange in color.

The irradiated second filtrate was then sent to the TestAmerica Lab for selenium speciation testing. The TestAmerica Lab UV sample results showed a selenate concentration of 31 μ/L, a selenite concentration of ND, and a selenocyanate concentration of 0.56 u/L, which did not meet the 1 μ/L threshold levels required for power plant discharge. Total selenium was reduced to 44 μ/L, but again well above the power plant discharge level of 5 μ/L.

The pre-treatment method provides an inexpensive chemical installation and method to remove heavy metals and selenium from industrial waters to meet drinking water discharge standards for selenium of less than 0.05 mg/L. Further, the filtered wastewaters are exposed to ultraviolet light for sufficient time for disinfection, making them safe to use.

To meet the most restrictive selenium discharge standard for Flue Gas Discharge under the Steam Electric Power Generating Point Source Regulations for New Source Performance Standards for effluent discharge of 1 μg/L total selenium, additional processes, such as biological reduction, reverse osmosis, or membrane removal must therefore be included at the above pre-treatment, which removes most of the heavy metals, and other precipitates, while providing a disinfected antiscalent water for further treatment. Pre-treatment thus significantly reduces loading before applying other selenium removal methods, and saves pumping and other energy costs associated with biological reduction, reverse osmosis, chemical reduction, and membrane removal.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description.

We claim:

1. A scaling inhibitor and disinfectant method comprising injecting sulfur dioxide into waters containing bicarbonates to adjust pH to approximately 6.5 for bicarbonate reduction to reduce scaling by controlling the Langelier Saturation Index, self-agglomerate acid precipitated solids for filtration removal, and inactivate pathogens and biofilms.

2. A scaling inhibitor and disinfectant method according to claim 1, wherein the sulfur dioxide is produced by a sulfurous acid generator located on or off site to oxidize raw sulfur for injection into the waters containing bicarbonates by wet scrubbing resultant sulfur dioxide gas.

3. A scaling inhibitor and disinfectant method according to claim 1, wherein the waters are brine waters containing salts.

4. A scaling inhibitor and disinfectant treatment method comprising:
a. raising the pH of influent and brine waters entering reverse osmosis membranes above pH 8.5 with lime to form metal hydroxide precipitates with adsorbed selenium, calcium precipitates, and metal sulfate precipitates,
b. removing the metal hydroxide precipitates, calcium precipitates, and metal sulfate precipitates forming a salt reduced filtrate,
c. adding sulfurous acid to the salt reduced filtrate to adjust the pH of the filtrate to approximately 6.5 to self-agglomerate acid precipitated solids for filtration removal, and add bisulfites for inactivating pathogens and biofilms to reduce loading on the reverse osmosis membranes.

5. A scaling inhibitor and disinfectant treatment method according to claim 4, including adding iron cations and sulfates to the influent entering the reverse osmosis membranes before raising the pH to insure sufficient iron cation concentrations for selenium adsorption.

6. A scaling inhibitor and disinfectant treatment method according to claim 4, including exposing the pH 6.5 filtrate to ultra violet light to kill microorganisms.

7. A scaling inhibitor and disinfectant treatment method according to claim 6, wherein the ultra violet light exposure time is sufficient to inactivate pathogens and viruses.

8. A scaling inhibitor and disinfectant treatment method according to claim 4, including aerating the treated water to provide dissolved oxygen where required for open stream discharge.
